(19) United States
(12) Patent Application Publication
(10) Pub. No.: US 2025/0088031 A1
(43) Pub. Date: Mar. 13, 2025

(54) ELECTRICAL GRID POWER SOURCE DETERMINATION USING TRACKING SIGNAL

(71) Applicant: INTERNATIONAL BUSINESS MACHINES CORPORATION, ARMONK, NY (US)

(72) Inventors: Brian Charles Tucker, Clinton Corners, NY (US); Marc Henri Coq, Hopewell Junction, NY (US); Enver Candan, Fishkill, NY (US)

(21) Appl. No.: 18/466,268

(22) Filed: Sep. 13, 2023

(51) Int. Cl. H02J 13/00; H02J 3/02; H02J 3/38

(52) U.S. Cl. CPC H02J 13/00002; H02J 3/02; H02J 3/381; H02J 13/00028

(57) ABSTRACT

A technique for determining an electrical grid power source using a power line signal which includes electronic communication using a power line between a host device and power supply units (PSUs) on an electrical power grid. The host device can designate a PSU as a signal generator and designate remaining PSUs as signal receivers. The host device generates a signal onto the power line used by the PSUs. The signal is detected at each of the receivers on the power line. A response by one of the receivers to the host device, is in response to the detection of the signal at the receiver. An electronic communication device receives communication from the host device that the signal is detected by the receiver.

### BACKGROUND

The present disclosure relates to the field of providing multiple electrical power sources and the determination of an electrical power source on an electrical power line or electrical grid.

Electronic equipment, such as equipment used for information technology, communications, power line carrier communication (PLCC) automation and control, industrial equipment, or other equipment, operates in a high-availability fashion which requires a robust electrical power source. Equipment that is designed for such operating conditions generally have separate, redundant, power supplies or connections as part of the equipment.

Often, facilities that utilize such equipment will provide electrical utility power that is sourced from two separate, independent, utility grids as a means of improving the overall availability of the equipment's function. Within these facilities, there can exist the risk that the equipment may not be connected properly, due to human error or other factors, resulting in a condition where the redundant utility input connections may be connected to the same utility feed rather than the facility-provided independent connections.

A connection error as described above, will reduce the overall availability of the connected equipment and may prolong any associated outage. Moreover, the connection error can remain unnoticed until an outage occurs, which also increases the time it takes to pinpoint the actual problem.

### SUMMARY

The present disclosure recognizes the shortcomings and problems associated with current techniques for determining electrical grid separation for electrical power sources. The problems are even more pronounced on computer equipment/server's racks electrical power grid. Embodiments of the present invention provide techniques for determining power generation on an electrical grid or power line by tracking an electrical signal on the power line. Embodiments of the present invention solve the problem of the determination of an electrical power source on an electrical power line or electrical grid.

In an aspect according to the present invention, a method for determining an electrical grid power source using a power line signal includes establishing electronic communication using a power line between a host device and power supply units (PSUs) on an electrical power grid. The method includes using the host device, designating a PSU as a signal generator, and designating remaining PSUs as receivers. The method includes generating, using the host device, a signal onto the power line used by the PSUs, and detecting the signal at each of the receivers on the power line. The method includes responding, by one of the receivers, to the host device, in response to detecting the signal at the receiver; and reporting to an electronic communication device, using the host device, the signal being detected by the receiver.

In one example, the host device is a microcontroller.

In one example, the signal is a unique signal distinguishable from other signals on the power line.

In one example, signal is generated from a microcontroller as the host device and the microcontroller is part of a power supply unit on the electrical power grid.

In one example, the communication to the user includes displaying on a display of the device a textual communication indicating the detection of the signal by the receiver.

In a related aspect, the method includes generating the signal using a signal generator communicating through an EMI (Electromagnetic Interference) filter.

In a related aspect, the method includes generating the signal using a regulation modulator communicating through a PFC (Power Factor Correction) circuit.

In a related aspect, the method includes designating one of a plurality of devices, as the host device, and each of the plurality of devices electrically communicating through the PSUs on the electrical grid, respectively.

In a related aspect, the method further includes designating each of the plurality of devices, in succession during a time period, as the host device, and correspondingly each of the PSUs as the receivers.

In a related aspect, the reporting to the device communicates (display) to a user the receiving of the signal by the receiver.

In another aspect according to the present invention, a system for determining an electrical grid power source using a power line signal includes: a host device and power supply units (PSUs) using an electrical power grid and electrically communicating; a PSU associated with the host device being designated as a signal generator, and the remaining PSUs being designated as receivers; and a signal being generatable using the host device onto the power line used by the PSUs and being detectable by each of the receivers on the power line, a response to the host device being generated by one of the receivers when the signal is detected at the one of the receivers, and a communication being sent to an electronic communication device by the host device, to indicate that the signal was detected by the receiver.

In a related aspect, the host device is a microcontroller.

In a related aspect, the signal is a unique signal distinguishable from other signals on the power line.

In a related aspect, the unique signal is generated from a microcontroller as the host device and the microcontroller is part of a power supply unit on the electrical power grid.

In a related aspect, the communication to the user includes displaying on a display of the device a textual communication indicating the detection of the signal by the receiver.

In a related aspect, the system includes generating the signal using a signal generator communicating through an EMI (Electromagnetic Interference) filter.

In a related aspect, the system further includes generating the signal using a regulation modulator communicating through a PFC (Power Factor Correction) circuit.

In a related aspect, the system further includes designating one of a plurality of devices as the host device, and each of the plurality of devices electrically communicating with the PSUs on the electrical grid, respectively.

In a related aspect, the system further including designating each of the plurality of devices, in succession during a time period, as the host device, and correspondingly each of the PSUs as the receivers.

In another aspect, according to the present invention, for determining an electrical grid power source using a power line signal, includes: a host device electrically communicating with an electrical power grid, the host device communicating with power supply units (PSUs) using the electrical power grid, a PSU being designated as a signal generator, and the remaining PSUs being designated as signal receivers, a signal being generatable using the host device onto a power line of the electrical grid used by the PSUs and being detectable by each of the receivers on the power line, a response to the host device being generated by one of the receivers when the signal is detected at the one of the receivers, and a communication being sent to an electronic communication device by the host device, to indicate that the signal was detected by the receiver.

In another aspect, according to the present invention, for determining an electrical grid power source using a power line signal, includes: a computer system comprising; a computer processor, a computer-readable storage medium, and program instructions stored on the computer-readable storage medium being executable by the processor, to cause the computer system to perform the following functions to; establish electronic communication using a power line between a host device and power supply units on an electrical power grid; using the host device, designate a PSU as a signal generator, and designate remaining PSUs as signal receivers; generate, using the host device, a signal onto the power line used by the PSUs; detect the signal at each of the receivers; respond, by one of the receivers, to the host device, in response to detecting the signal at the receiver; and report to an electronic communication device, using the host device, the signal being detected by the receiver.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are discussed forthwith below.

FIG. 1 is a flow chart of a method, according to an embodiment of the present disclosure, which can use the system depicted in FIG. 2, for determining an electrical grid power source using a power line signal.

FIG. 2 is a schematic block diagram illustrating a system according to an embodiment of the present disclosure, for determining an electrical grid power source using a power line signal.

FIG. 3 is a schematic block diagram of a system, according to another embodiment of the present disclosure, for determining an electrical grid power source using a power line signal.

FIG. 4 is a schematic block diagram of another sample system, according to another embodiment of the present disclosure, for determining an electrical grid power source using a power line signal.

FIG. 5 is a schematic block diagram illustrating a system according to an embodiment of the present disclosure, for determining an electrical grid power source using a power line signal.

FIG. 6 is a flow chart illustrating another method according to an embodiment of the present invention, using the system shown in FIG. 5, for determining an electrical grid power source using a power line signal.

FIG. 7 is a schematic block diagram depicting a computer system according to an embodiment of the disclosure, which includes cloud computing components and functions, and which can cooperate with the systems and methods shown in the figures and described herein.

### DETAILED DESCRIPTION

The following description with reference to the accompanying drawings is provided to assist in a comprehensive understanding of exemplary embodiments of the invention as defined by the claims and their equivalents. The description includes various specific details to assist in that understanding, but these are to be regarded as merely exemplary, and assist in providing clarity and conciseness. Accordingly, those of ordinary skill in the art will recognize that various changes and modifications of the embodiments described herein can be made without departing from the scope and spirit of the invention. In addition, descriptions of well-known functions and constructions may be omitted.

The terms and words used in the following description and claims are not limited to the bibliographical meanings but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

### Embodiments and Examples

Embodiments and figures of the present disclosure may have the same or similar components as other embodiments. Such figures and descriptions illustrate and explain further examples and embodiments according to the present disclosure. Embodiments of the present disclosure can include operational actions and/or procedures. A method, such as a computer-implemented method, can include a series of operational blocks for implementing an embodiment according to the present disclosure which can include cooperation with one or more systems shown in the figures. The operational blocks of the methods and systems according to the present disclosure can include techniques, mechanism, modules, and the like for implementing the functions of the operations in accordance with the present disclosure. Similar components may have the same reference numerals. Components can operate in concert with a computer implemented method. It is understood that a user, for example, can include an individual, or a group of individuals, or a company or an organization, or a customer.

Embodiments of the present disclosure can include a system or method for determining if two (or more) incoming electrical utility feeds may be originating from the same source, or if they are separately-sourced power feeds. The environment can be single-phase AC (alternating current), multi-phase AC, as well as DC (direct current) systems. In one embodiment a signal generation device is incorporated into line-connected equipment, which intentionally generates a unique signal intended to propagate along a local power grid. An accompanying technique of receiving the generated signal is also incorporated into the equipment. In one example, the signal is unique in relation to any other signal that may be present in the system, such as an electrical noise that has a unique frequency and magnitude. In another example, the signal differs from what is commonly seen or detected on an AC line.

In one example, a microcontroller is utilized to enable the signal generator on one piece of equipment while simultaneously enabling the receivers within the other line connected devices. The receivers can report the presence or absence of the generated signal to the host microcontroller, indicating whether or not a particular line-connected device was cabled to the same electrical grid connection as the device containing the active signal generator.

Embodiments of the present disclosure can be incorporated as part of the installed system, so that energy feed independence checks can be run at the time of installation, on-demand manually, at periodic intervals, or after maintenance/repair operations at either the system, facility, or utility level. Additionally, embodiment of the present disclosure may be implemented as a standalone tool, providing useful guidance at the time of product installation. Additionally, embodiment of the present disclosure may be powered by the energy feeds under test, or from an independent power source such as a battery or unrelated power connection.

In general, a method according to the present disclosure can include the following operations, which can be incorporated into one or more embodiments, whether implementation, either as an integrated feature, or as a standalone tool. The method includes initializing all test and instrumentation hardware. The method includes initiating signal generation from one of the connected devices to a power grid. The method includes initializing receivers on all other connected devices. The method includes waiting for receivers to indicate presence or absence of a signal. The method further includes a host microcontroller collecting data from receivers and reporting connection status of line-connected devices. The method includes disabling the running signal generator. The method includes repeating test steps using the signal generator in the next device. This process will continue until each line-connected device has had an opportunity to perform the role of both generator and receiver, thus evaluating all possible connection permutations. The method can include an optional operation including the test battery being repeated during run-time operation of the connected devices, when the devices have been equipped with generator and reception circuitry that may allow for test during normal operation.

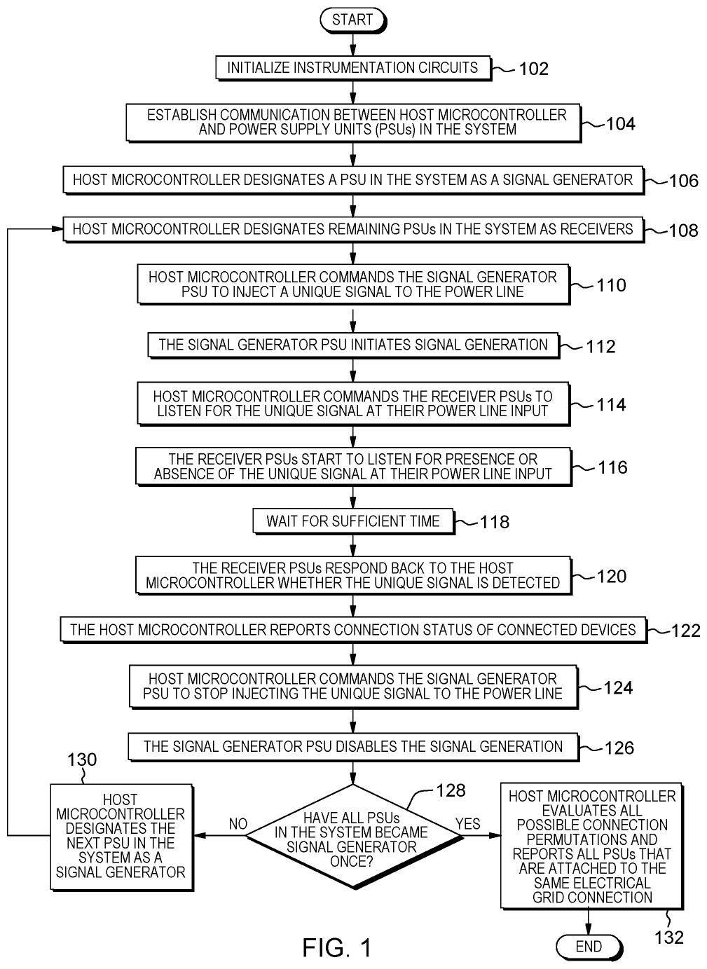

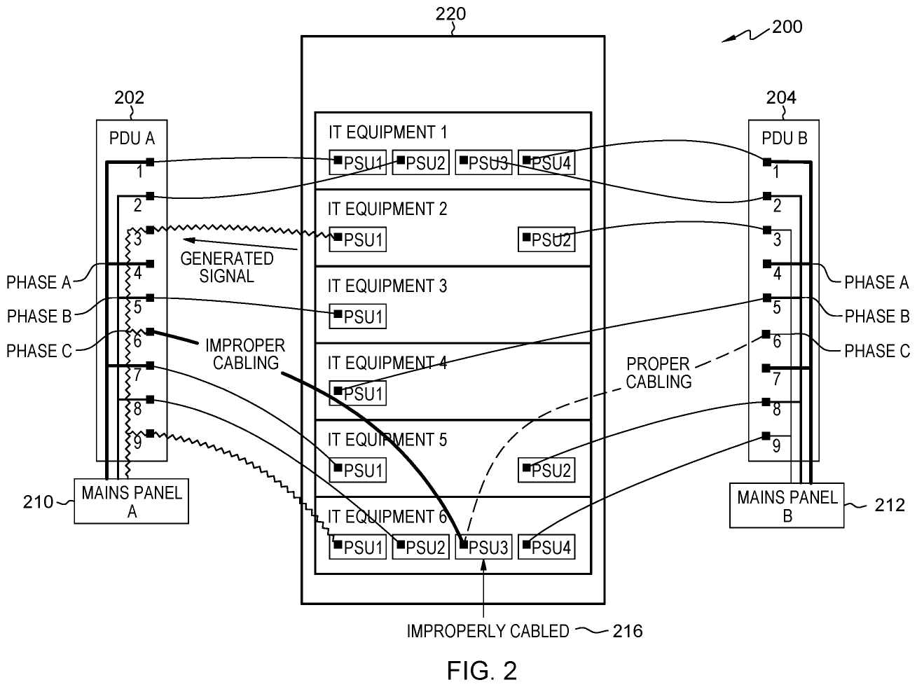

Referring to FIG. 1, and also with reference to a system 200 shown in FIG. 2, a method 100 according to an embodiment of the present disclosure for determining electrical grid power source separation using a power line signal, includes initializing instrument circuits, as in operation 102. The method includes establishing communications between a host microcontroller and power supply units (PSUs) in an electrical system or grid, as in operation 104. The method includes a host microcontroller designating a PSU in the system as a signal generator, as in operation 106. The method includes the host microcontroller designating remaining PSUs in the system as receivers, as in operation 108. The method includes the host microcontroller generating commands to a signal generator PSU to inject a unique signal into a power line of the system or grid, as in operation 110. The method includes the signal generator PSU initiating the signal generation, as in operation 112. The method includes the host microcontroller generating a command to the receiver PSUs to listen for the unique signal at their power line input, as in operation 114. The method includes the receiver PSUs initiating listening for presence or absence of the unique signal at their respective power line inputs, as in operation 116. The method includes waiting a sufficient or specified amount of time, as in operation 118. The method includes the receiver PSUs responding back to the host microcontroller when the unique signal is detected, as in operation 120. The method includes the host microcontroller reporting a connection status of connected devices, as in operation 122. For example, if a receiver PSU responds back with the presence of a signal, the host microcontroller records that the receiver PSU and the signal generator PSU are attached to the same electrical gird connection. The method includes the host microcontroller commanding the signal generator PSU to stop injecting the unique signal to the power line, as in operation 124. And the method includes the signal generator PSU disabling the signal generation, as in operation 126. The method includes determining when all of the PSUs in the system become signal generator at least once in operation 128. If not, in operation 128, the method advances to operation 130 where the host microcontroller designates the next PSU in the system as a signal generator. If the determination is affirmative in operation 128, the method proceeds to the host microcontroller evaluating all possible connection permutations and reports all PSUs that are attached to the same electrical grid connection, as in operation 132.

Referring to FIG. 2, a system 200 according to an embodiment of the present disclosure, includes IT (Information Technology) equipment rack 220 with two 3-phase PDUs (namely PDU A 202 and PDU B 204) and each PDU is connected to a separate mains panel (namely Mains Panel A 210 and Mains Panel B 212). Each of the PDUs includes electrical power phases: Phase A, Phase B and Phase C. The IT equipment rack 220 includes IT equipment 1, IT equipment 2, IT equipment 3, IT equipment 4, IT equipment 5, and IT equipment 6. In this example, IT Equipment 6, PSU 3 has improper power cabling 216, it is connected to PDU A 202, but it should be connected to PDU B 204 for high-availability.

According to the disclosed invention, each PSU in the system 200 becomes a signal generator once, while the remaining PSUs in the system become receivers and report whether the signal generated by the signal generator PSU is detected or not. In this example, the method detects improper power cabling when IT Equipment 2, PSU 1 generates a signal and IT Equipment 6, PSU 3 detects the signal.

Alternatively, the same can be concluded when IT Equipment 6, PSU 1 generates a signal and IT Equipment 6, PSU 3 detects the signal. And alternatively, the same can be concluded when IT Equipment 6, PSU 3 generates a signal and IT Equipment 6, PSU 1 or IT Equipment 2, PSU 1 detects the signal.

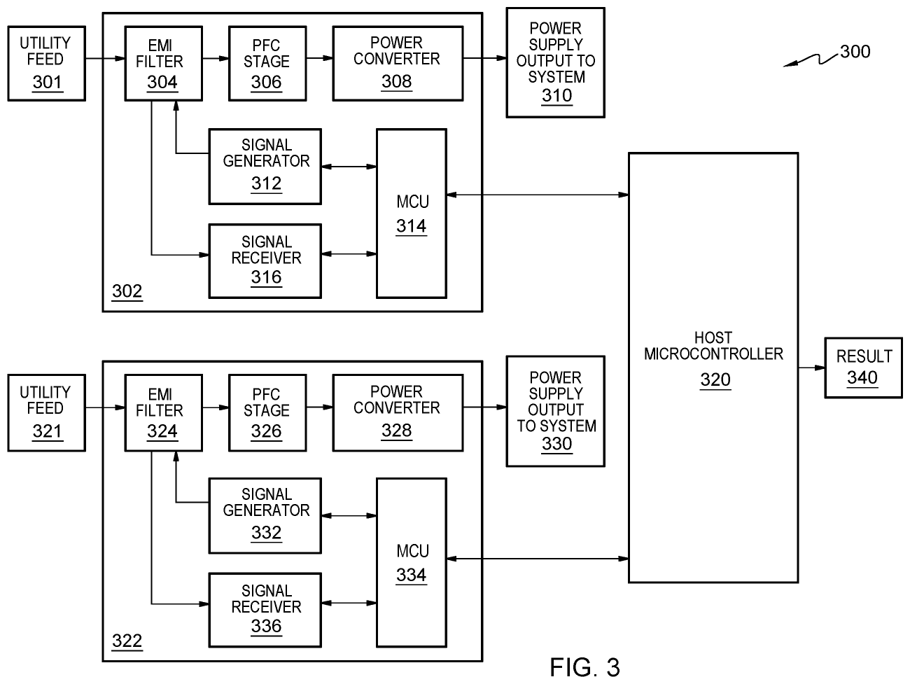

Referring to FIG. 3, a system 300 according to one embodiment of the present disclosure, includes a utility feed 301 and another utility feed 321 which is distinct and independent from the utility feed 301. In the system 300 a signal generator 312 generates a signal as instructed to by MCU 314 and adds it to utility feed 301 through input filter section 304 of a power supply unit 302, such that the input filter 304 itself does not attenuate or otherwise harm the generated or received signal. The signal receiver 316 is similarly located. The signal injection and reception circuitry are otherwise not an active part of the power supply unit. The structures of EMI filters 304, 324 are designed such that they protect the signal generation circuitry from damaging transient voltages on the utility feed as well as shielding the signal receiver 316 from electrical noise generated by the power supply PFC 306 and power converter 308 stages.

For example, the utility feed 301 feeds an EMI (electromagnetic interference) filter 304 connected to a PFC (Power Factor Correction) stage 306 (e.g., a PFC circuit) which in turn feeds power converter 308 which inputs into the power supply output 310 of the system. The EMI filter feeds into a signal receiver 316 which separates the desired signal from any incident line noise and communicates the discriminated signal with a (MCU) microcontroller 314. The MCU 314 communicates with a host microcontroller 320 which communicates results 340.

Similar, the utility feed 321 feeds into a power supply unit 322 which include feeding an EMI filter 324 connected to a PFC stage 326 which in turn feeds power converter 328 which inputs into the power supply output 330 of the system. The EMI filter feeds into a signal receiver 336 which communicates with MCU 334, which in turn communicates with a signal generator 332. The MCU 334 communicates with the host microcontroller 320.

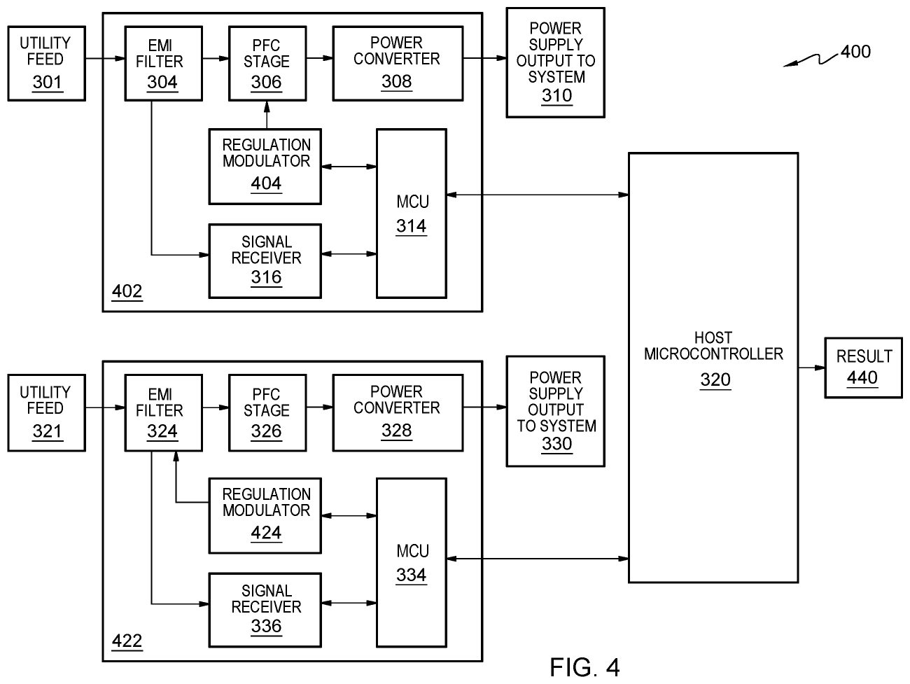

Referring to FIG. 4, according to another embodiment of the present disclosure, a system 400 includes a signal generated by modulating the regulation reference of a conventional power factor correction boost converter in a typical power supply unit. Regulation Modulator 404 controls the PFC Stage 306 to generate a signal which eliminates the need for separate generation circuitry and allows for simple inclusion into digital power control schemes. The receiver 316 is still separate, and connected such that the EMI filter does not harm the incoming signal to be detected.

For example, the utility feed 301 feeds into a power supply unit 402 which feeds an EMI filter 304 connected to a PFC stage 306 which in turn feeds power converter 308 which inputs into the power supply output 310 of the system. The EMI filter feeds into a signal receiver 316 which communicates with the MCU 314, which in turn communicates with a regulation modulator 404. The MCU 314 communicates with the host microcontroller 320 which communicates the results 440.

Similarly, the utility feed 321 feeds into a power supply unit 422 which feeds an EMI filter 324 connected to a PFC stage 326 which in turn feeds power converter 328 which inputs into the power supply output 330 of the system. The EMI filter feeds into a signal receiver 336 which communicates with the MCU 334, which in turn communicates with a regulation modulator 424. The MCU 334 communicates with the host microcontroller 320.

In one example, as explained above, the PSU 402 is the generating device, PSU 422 is the signal receiving device. Therefore, signal receive 316 and regulation modulator 424 are not active. Host microcontroller 320 assigns the signal generator role to PSU 402, and signal listener role to all other PSUs in the system, one of which is depicted as PSU 422 in FIG. 4. MCU 314 uses regulation modulator 404 to generate the signal using PFC Stage 306, the signal travels thru EMI filter 304 to Utility Feed 301. If PSU 422 is in the same utility feed as the PSU 402, the signal is picked up by signal receiver 336 thru EMI filter 324 because PSU 422 is the listener as constructed by MCU 334 and Host Micro 320. Therefore, MCU 334 reports presence of signal, meaning PSU 422 and PSU 402 are in the same utility feed. If PSU 422 is NOT in the same utility feed as the PSU 402, the signal generated by PSU 402 is not picked up by the signal received 336 therefore MCU 334 reports absence of signal, meaning PSU 422 and PSU 402 are NOT in the same utility feed.

Thereby, a method is provided for generating and receiving tracing signals within line-connected equipment. The method utilizes signal generators which can be added to the equipment or can take advantage of existing digital power stage control technology by providing signal generation through modulation of existing power circuitry. PSU microcontrollers and a host microcontroller are utilized to orchestrate the tests and can complete all line tracing in an automatic fashion. PSU microcontrollers generate and process the signals to perform the role of both generator and receiver, directed by the host microcontroller. The method validates all possible power cabling connection permutations are proper.

Embodiments of the present disclosure enable the ability to detect if two separate, independent power feeds are present in a electrical system. A combination of analog and digital signal generation and reception circuitry in conjunction with local and host microcontrollers can be used to perform testing. Existing power conversion stages can be used to perform the signal generation, allowing for reduced component count and higher power signal generation. The methods and system of the present disclosure provide time zero or runtime diagnostic information to host system. A system embodying the present disclosure can be built into power system subassemblies (Power Supplies, Power Distribution Units, infrastructure management tools, etc.). Embodiments can provide assurance of power redundancy/reliability in high availability environments.

### Other Embodiments and Examples

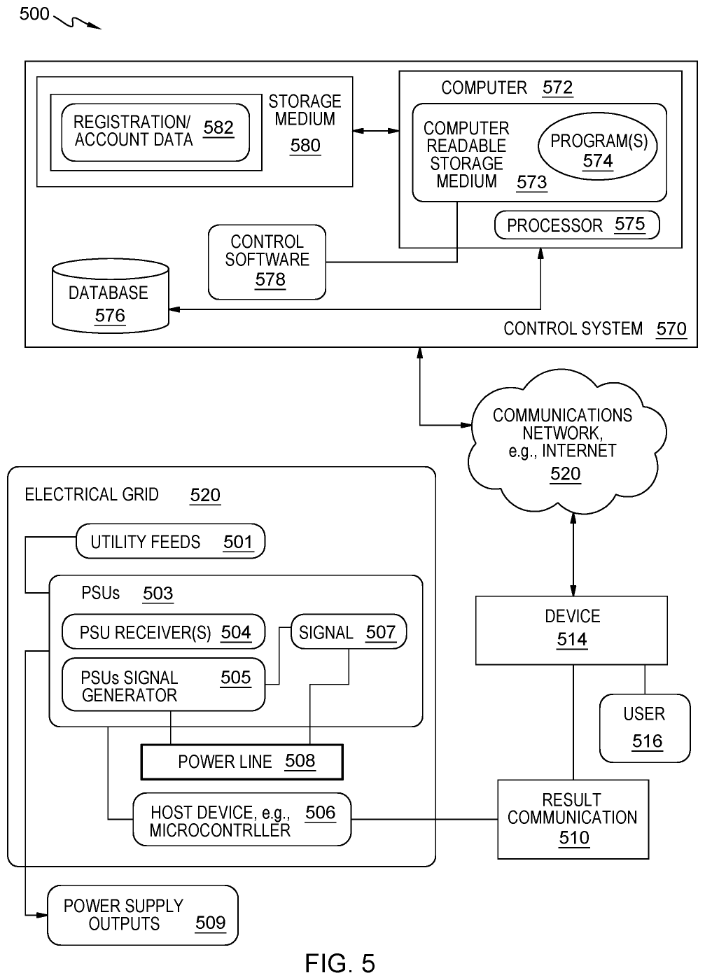

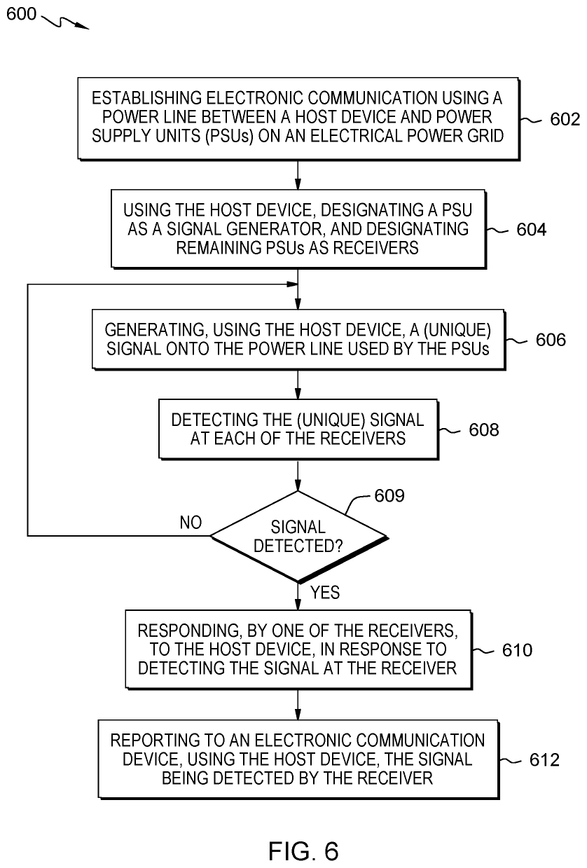

Referring to FIGS. 5 and 6, according to an embodiment of the present disclosure, a method 600, utilizing a system 500, can determine an electrical grid 502 power source, such as multiple utility feeds 501, using a power line 508 signal 507. The method 600 includes establishing electronic communication using a power line 508 between a host device 506 such as a microcontroller, and power supply units (PSUs) 503 on an electrical power grid, as in operation 602. The PSU electrically communicates with utility feeds 501 and provides power supply outputs 509.

The method 600 includes using the host device 506, designating a PSU as a signal generator 505, and designating remaining PSUs as receivers 504, as in operation 604.

The method includes generating, using the host device, a signal 507 onto the power line 508 used by the PSUs 503, as in operation 606. In one example, the signal is unique with respect to other electrical signals on the power line. In one example, the PSU designated as the primary signal generator injects a signal onto the power line used by the PSUs.

The method includes detecting the signal 507 at one or more of the receivers 504, as in operation 608. In one example, the signal is detected at each of the receiver PSUs that are on the same power line as the generator PSU.

The method determines when the signal is detected at operation 609. When the signal is not detected, the method returns to operation 606. When the signal is detected, the method proceeds to operation 610.

The method includes responding, by one of the receivers, to the host device, in response to detecting the signal at the receiver, and reporting via an electronic communication reporting the result 510 to an electronic communication device 514, using the host device 506, the signal being detected by the receiver 504, as in operation 612.

The process can continue until each PSU has had an opportunity to perform the role of both generator and receiver, thus evaluating all possible connection permutations.

In one example, the host device is a microcontroller. In another example, the signal is a unique signal distinguishable from other signals on the power line. In another example, the unique signal is generated from a microcontroller as the host device and the microcontroller is part of a power supply unit on the electrical power grid. In another example, the communication 510 to a device 514 for a user 516 includes displaying on a display of the device 514 a textual communication indicating the detection of the signal by the receiver.

The method can further include generating the signal using a signal generators 312, 332 communicating with an EMI (Electromagnetic Interference) filter 304.

The method can further include generating the signal using a regulation modulators 404, 424 communicating with a PFC (Power Factor Correction) circuit 306, 326.

The method can further include designating one of a plurality of devices, as the host device, and each of the plurality of devices electrically communicating with the PSUs on the electrical grid, respectively.

The method can further include designating each of the plurality of devices, in succession during a time period, as the host device, and correspondingly each of the PSUs as the receivers. Thereby, the method can exhaust all combinations of designating the devices as host and receiving devices.

In one example, the reporting to the device communicates (e.g., using a display) to a user the receiving of the signal by the receiver.

In another embodiment according to the present disclosure, a system for determining an electrical grid power source using a power line signal includes a host device and power supply units (PSUs) using an electrical power grid. A PSU associated with the host device being designated as a signal generator 505, and the remaining PSUs 503 being designated as receivers 504. A signal 507 is generatable using the host device 506 onto the power line 508 used by the PSUs 503 and being detectable by each of the receivers. A response to the host device being generated by one of the receivers when the signal is detected at the one of the receivers, and a communication 510 being sent to an electronic communication device 514 by the host device, to indicate that the signal was detected by the receiver.

In another embodiment according to the present disclosure, an apparatus for determining an electrical grid power source using a power line signal include a host device 506 electrically communicating with an electrical power grid 502. The host device communicating with power supply units (PSUs) 504 using the electrical power grid. A PSU associated with the host device is designated as a signal generator 505, and the remaining PSUs 503 being designated as receivers 504. A signal 507 is generatable using the host device onto a power line 508 of the electrical grid used by the PSUs and being detectable by each of the receivers. A response to the host device being generated by one of the receivers when the signal is detected at the one of the receivers, and a communication 510 being sent to an electronic communication device 514 by the host device, to indicate that the signal was detected by the receiver.

In another embodiment according to the present disclosure, another system for determining an electrical grid power source using a power line signal includes a computer system 572 including a computer processor 575, a computer-readable storage medium 573, and program instructions 574 stored on the computer-readable storage medium 573 being executable by the processor 575, to cause the computer system to perform the functions to establish electronic communication using a power line between a host device and power supply units (PSUs) on an electrical power grid. The system includes the function to use the host device, designate a PSU as a signal generator, and designating remaining PSUs as receivers. The system includes the function to generate, using the host device, a signal onto the power line used by the PSUs. The system includes the function to detect the signal at each of the receivers, and respond, by one of the receivers, to the host device, in response to detecting the signal at the receiver. The system includes the function to report to an electronic communication device, using the host device, the signal being detected by the receiver.

In another embodiment according to the present disclosure, a computer program product for determining an electrical grid power source using a power line signal where the computer program product includes a computer readable storage medium having program instructions embodied therewith, the program instructions executable by a computer to cause the computer to perform functions, by the computer, including the functions to establish electronic communication using a power line 508 between a host device 506 and power supply units (PSUs) 503 on an electrical power grid 502. The computer program product includes functions to use the host device, to designate a PSU as a signal generator, and designating remaining PSUs as receivers 504. The computer program product includes functions to generate, using the host device, a signal onto the power line used by the PSUs, and detect the signal at each of the receivers. The computer program product includes functions to respond, by one of the receivers, to the host device, in response to detecting the signal at the receiver, and report to an electronic communication device, using the host device, the signal being detected by the receiver.

### Additional Embodiments and Examples

In the present disclosure, an electronic device generates a unique signal at a power line it is connected to, and another electronic device checks whether the unique signal exists at the power line it is connected to. Thereby, identifies proper electrical grid connections are identified. In another example, a unique signal is injected into the power line by a signal generator device, and the receiving devices monitor their power line to detect the existence of the unique signal to identify proper electrical grid connections across the power devices. The electronic devices that are connected to the power system are equipped to be both a signal generator and a receiver. And, each electronic device has an opportunity to perform the role of both signal generator and receiver which enables all possible connection permutations to be evaluated.

Thereby, in one example, a method and/or a system for determining electrical grid separation using a power line signal can include initiating electronic communication between a host microcontroller and power supply units (PSU) using a power line. The method or system can use the host microcontroller to designate a PSU as a signal generator, and designate remaining PSUs as receivers. The method or system can generate, using the microcontroller, a unique signal into the power line used by the PSUs. The method or system can detect the unique signal at each of the receivers; and respond to the microcontroller using one of the receivers, in response to the detecting of the unique signal. And, the method or system can report, using the host microcontroller, the unique signal being detected by the receiver, to a computer for display to a user.

In another example, a host microcontroller will look at how a system is supposed to be connected and will instruct one of the power supply MCUs to send out a test signal. This will start up the signal generator and inject the desired signal into the EMI filter where it will find its way out onto the utility feed while still having some of the filter elements so as to protect it from utility line transient voltage spikes. This signal is unique in such a way that it can easily be distinguished from other noise on the line.

While the one power supply has been instructed to generate the signal the others will be instructed to ‘listen’ for the signal. The host microcontroller will communicate with the local MCU inside the power supplies and instruct them to start the signal receiver and start decoding the signal. The receiver will be receiving the signal via the utility feed and through the front end of the EMI filter. Again, part of the filter's purpose is to prevent excessive line noise from going to the receiver, and also to protect it from any utility line transient voltage spikes. Additionally, the filter will absorb or block some of the noise generated from the power conversion circuitry so as to not overwhelm the receiver itself.

The receivers will all report the presence or absence of any signal back to the MCU, and the host microcontroller can compile a table of what was received, and by what power supply unit. At this point it will begin signal generation in a different PSU while listening to all others. This will continue to move along until all permutations are exhausted and the connection diagram of the system can be determined.

### Other Examples and Embodiments

In other embodiments and examples, in the present disclosure shown in the figures, a computer can be part of a remote computer or a remote server, for example, a remote server. In another example, the computer can be part of a control system and provide execution of the functions of the present disclosure. In another embodiment, a computer can be part of a mobile device and provide execution of the functions of the present disclosure. In still another embodiment, parts of the execution of functions of the present disclosure can be shared between the control system computer and the mobile device computer, for example, the control system function as a back end of a program or programs embodying the present disclosure and the mobile device computer functioning as a front end of the program or programs. A device(s), for example a mobile device or mobile phone, can belong to one or more users, and can be in communication with the control system via the communications network.

The computer can be part of the mobile device, or a remote computer communicating with the mobile device. In another example, a mobile device and a remote computer can work in combination to implement the method of the present disclosure using stored program code or instructions to execute the features of the method(s) described herein. In one example, the device can include a computer having a processor and a storage medium which stores an application, and the computer includes a display. The application can incorporate program instructions for executing the features of the present disclosure using the processor. In another example, the mobile device application or computer software can have program instructions executable for a front end of a software application incorporating the features of the method of the present disclosure in program instructions, while a back end program or programs, of the software application, stored on the computer of the control system communicates with the mobile device computer and executes other features of the method. The control system and the device (e.g., mobile device or computer) can communicate using a communications network, for example, the Internet.

Methods and systems according to embodiments of the present disclosure, can be incorporated in one or more computer programs or an application stored on an electronic storage medium, and executable by the processor, as part of the computer on mobile device. For example, a mobile device can communicate with the control system, and in another example, a device such as a video feed device can communicate directly with the control system. Other users (not shown) may have similar mobile devices which communicate with the control system similarly. The application can be stored, all or in part, on a computer or a computer in a mobile device and at a control system communicating with the mobile device, for example, using the communications network, such as the Internet. It is envisioned that the application can access all or part of program instructions to implement the method of the present disclosure. The program or application can communicate with a remote computer system via a communications network (e.g., the Internet) and access data, and cooperate with program(s) stored on the remote computer system. Such interactions and mechanisms are described in further detail herein and referred to regarding components of a computer system, such as computer readable storage media, which are shown in one or more embodiments herein and described in more detail in regards thereto referring to one or more computers and systems described herein.

Also, referring to the figures, a device can include a computer, computer readable storage medium, and operating systems, and/or programs, and/or a software application, which can include program instructions executable using a processor. Embodiments of these features are shown herein in the figures. The method according to the present disclosure, can include a computer for implementing the features of the method, according to the present disclosure, as part of a control system. In another example, a computer as part of a control system can work in corporation with a mobile device computer in concert with communication system for implementing the features of the method according to the present disclosure. In another example, a computer for implementing the features of the method can be part of a mobile device and thus implement the method locally.

Referring to one or more embodiments in the figures, a computer or a device, also can be referred to as a user device or an administrator's device, includes a computer having a processor and a storage medium where an application can be stored. The application can embody the features of the method of the present disclosure as instructions. The user can connect to a learning engine using the device. The device which includes the computer and a display or monitor. The application can embody the method of the present disclosure and can be stored on the computer readable storage medium. The device can further include the processor for executing the application/software. The device can communicate with a communications network, e.g., the Internet.

It is understood that the device is representative of similar devices which can be for other users, as representative of such devices, which can include, mobile devices, smart devices, laptop computers etc.

### Additional Examples and Embodiments

In one example, a system according to the present disclosure can include a control system communicating with a user device via a communications network. The control system can incorporate all or part of an application or software for implementing the method of the present disclosure. The control system can include a computer readable storage medium where account data and/or registration data can be stored. User profiles can be part of the account data and stored on the storage medium. The control system can include a computer having computer readable storage medium and software programs stored therein. A processor can be used to execute or implement the instructions of the software program. The control system can also include a database.

A control system can include a storage medium for maintaining a registration of users and their devices for analysis of the audio input. Such registration can include user profiles, which can include user data supplied by the users in reference to registering and setting-up an account. In an embodiment, the method and system which incorporates the present disclosure includes the control system (generally referred to as the back-end) in combination and cooperation with a front end of the method and system, which can be the application. In one example, the application is stored on a device, for example, a computer or device on location, and can access data and additional programs at a back end of the application, e.g., control system.

Referring to the figures, and for example, FIG. 5, the system 500 includes a computer 572 which can be integral to or communicating with a device and communicate with other computers. The control system 570 can include the computer 572 having a computer readable storage medium 573 which can store one or more programs 574, and a processor 575 for executing program instructions, and can also include control software 578 for managing the one or more programs. The control system can also include a storage medium 580 which can include registration and/or account data 582 which can include user profiles of users or entities (such entities can include robotic entities) as part of user accounts. The programs 574 or code can be embedded on the storage medium. The program code can be executed by a processor 575. The computer 572 can communicate with a database 576. The control system 570 can also include a database 576 for storing all or part of such data as described above, and other data.

The depiction of the computer system as well as the other components of the system are shown as one example according to the present disclosure. One or more computer systems can communicate with a communications network 520, e.g., the Internet. For example, the computer device 514, and the control system 570 can communicate with the communications network 520.

Thus, in one example, a control system can be in communication with a computer or device, and the computer can include an application or software. The computer, or a computer in a mobile device can communicate with the control system using the communications network. In another example, the control system can have a front-end computer belonging to one or more users, and a back-end computer embodied as the control system.

The control system can also be part of a software application implementation, and/or represent a software application having a front-end user part and a back-end part providing functionality. In an embodiment, the method and system which incorporates the present disclosure includes the control system (which can be generally referred to as the back-end of the software application which incorporates a part of the method and system of an embodiment of the present application) in combination and cooperation with a front end of the software application incorporating another part of the method and system of the present application at the device, which may be shown, for example, in the example figures, for instance an application stored on a computer readable storage medium of a computer or device. The application is stored on the device or computer and can access data and additional programs at the back end of the application, for example, in the program(s) stored in the control system.

The program(s) can include all or in part, a series of executable steps for implementing the method of the present disclosure. A program, incorporating the present method, can be all or in part stored in the computer readable storage medium on the control system or, in all or in part, on a computer or device. It is envisioned that the control system can not only store the profile of users, but in one embodiment, can interact with a website for viewing on a display of a device such as a mobile device, or in another example the Internet, and receive user input related to the method and system of the present disclosure. It is understood that embodiments shown in the figures depicts one or more profiles, however, the method can include multiple profiles, users, registrations, etc. It is envisioned that a plurality of users or a group of users can register and provide profiles using the control system for use according to the method and system of the present disclosure.

### Still Further Embodiments and Examples

Account data, for instance, including profile data related to a user, and any data, personal or otherwise, can be collected and stored, for example, in a control system. It is understood that such data collection is done with the knowledge and consent of a user, and stored to preserve privacy, which is discussed in more detail below. Such data can include personal data, and data regarding personal items.

In one example a user can register and have an account with a user profile on a control system. For example, data can be collected using techniques as discussed above, for example, using cameras, and data can be uploaded to a user profile by the user. A user can include, for example, a corporate entity, or department of a business, or a homeowner, or any end user, a human operator, or a robotic device, or other personnel of a business.

Regarding collection of data with respect to the present disclosure, such uploading or generation of profiles is voluntary by the one or more users, and thus initiated by and with the approval of a user. Thereby, a user can opt-in to establishing an account having a profile according to the present disclosure. Similarly, data received by the system or inputted or received as an input is voluntary by one or more users, and thus initiated by and with the approval of the user. Thereby, a user can opt-in to input data according to the present disclosure. Such user approval also includes a user's option to cancel such profile or account, and/or input of data, and thus opt-out, at the user's discretion, of capturing communications and data. Further, any data stored or collected is understood to be intended to be securely stored and unavailable without authorization by the user, and not available to the public and/or unauthorized users. Such stored data is understood to be deleted at the request of the user and deleted in a secure manner. Also, any use of such stored data is understood to be, according to the present disclosure, only with the user's authorization and consent.

In one or more embodiments of the present invention, a user(s) can opt-in or register with a control system, voluntarily providing data and/or information in the process, with the user's consent and authorization, where the data is stored and used in the one or more methods of the present disclosure. Also, a user(s) can register one or more user electronic devices for use with the one or more methods and systems according to the present disclosure. As part of a registration, a user can also identify and authorize access to one or more activities or other systems (e.g., audio and/or video systems). Such opt-in of registration and authorizing collection and/or storage of data is voluntary and a user may request deletion of data (including a profile and/or profile data), un-registering, and/or opt-out of any registration. It is understood that such opting-out includes disposal of all data in a secure manner. A user interface can also allow a user or an individual to remove all their historical data.

### Other Additional Embodiments and Examples

Additionally, methods and systems according to embodiments of the present disclosure can be discussed in relation to a functional system(s) depicted by functional block diagrams. The methods and systems can include components and operations for embodiments according to the present disclosure and is used herein for reference when describing the operational steps of the methods and systems of the present disclosure. Additionally, the functional system, according to an embodiment of the present disclosure, depicts functional operations indicative of the embodiments discussed herein.

The methods and systems of the present disclosure can include a series of operational blocks for implementing one or more embodiments according to the present disclosure. A method shown in the figures may be another example embodiment, which can include aspects/operations shown in another figure and discussed previously, but can be reintroduced in another example. Thus, operational blocks and system components shown in one or more of the figures may be similar to operational blocks and system components in other figures. The diversity of operational blocks and system components depict example embodiments and aspects according to the present disclosure. For example, methods shown are intended as example embodiments which can include aspects/operations shown and discussed previously in the present disclosure, and in one example, continuing from a previous method shown in another flow chart.

It is understood that the features shown in some of the figures, for example block diagrams, are functional representations of features of the present disclosure. Such features are shown in embodiments of the systems and methods of the present disclosure for illustrative purposes to clarify the functionality of features of the present disclosure.

### Further Discussion Regarding Examples and Embodiments

It is understood that a set or group is a collection of distinct objects or elements. The objects or elements that make up a set or group can be anything, for example, numbers, letters of the alphabet, other sets, a number of people or users, and so on. It is further understood that a set or group can be one element, for example, one thing or a number, in other words, a set of one element, for example, one or more users or people or participants. It is also understood that machine and device are used interchangeable herein to refer to machine or devices in one or ecosystems or environments, which can include, for example and artificial intelligence (AI) environment.

The descriptions of the various embodiments of the present invention have been presented for purposes of illustration but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein or limit the disclosure to the examples described herein. Such examples are intended to be examples or exemplary, and non-exhaustive. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is also understood that the one or more computers or computer systems shown in the figures can include all or part of a computing environment and its components shown in another figure, for example, the computing environment 1000 can be incorporated, in all or in part, in one or more computers or devices shown in other figures and described herein. In one example, the one or more computers can communicate with all or part of a computing environment and its components as a remote computer system to achieve computer functions described in the present disclosure.

### More Additional Examples and Embodiments

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

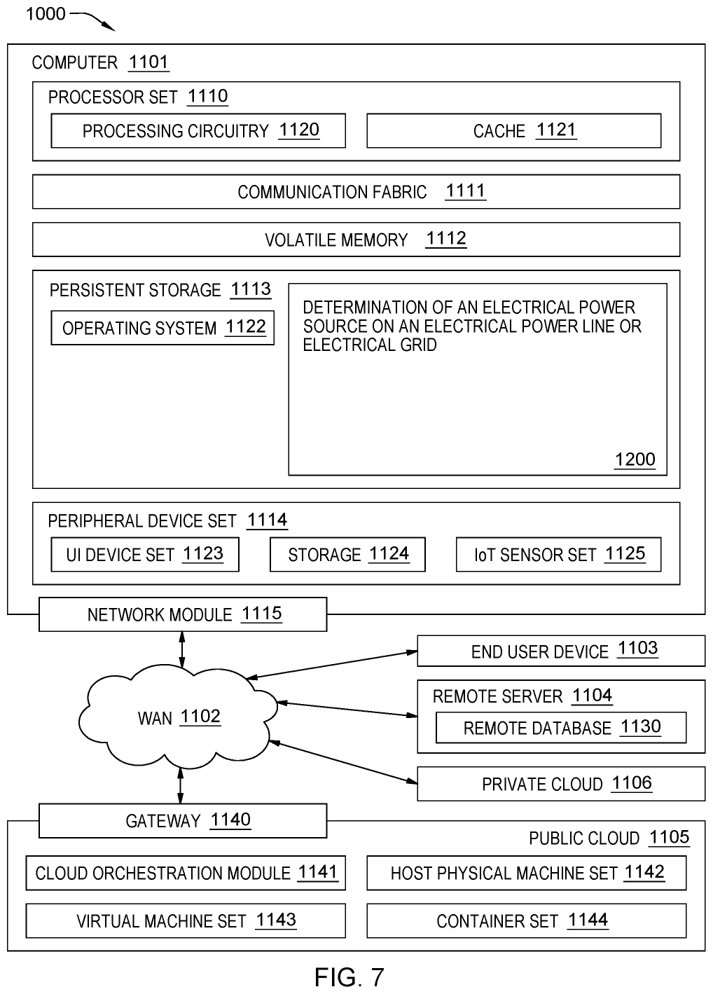

Referring to FIG. 7, a computing environment 1000 contains an example of an environment for the execution of at least some of the computer code involved in performing the inventive methods, such as determination of an electrical power source on an electrical power line or electrical grid 1200. In addition to block 1200, computing environment 1000 includes, for example, computer 1101, wide area network (WAN) 1102, end user device (EUD) 1103, remote server 1104, public cloud 1105, and private cloud 1106. In this embodiment, computer 1101 includes processor set 1110 (including processing circuitry 1120 and cache 1121), communication fabric 1111, volatile memory 1112, persistent storage 1113 (including operating system 1122 and block 1200, as identified above), peripheral device set 1114 (including user interface (UI), device set 1123, storage 1124, and Internet of Things (IoT) sensor set 1125), and network module 1115. Remote server 1104 includes remote database 1130. Public cloud 1105 includes gateway 1140, cloud orchestration module 1141, host physical machine set 1142, virtual machine set 1143, and container set 1144.

COMPUTER 1101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1130. As is well understood in the art of computer technology, and depending upon the technology, performance of a computer-implemented method may be distributed among multiple computers and/or between multiple locations. On the other hand, in this presentation of computing environment 1100, detailed discussion is focused on a single computer, specifically computer 1101, to keep the presentation as simple as possible. Computer 1101 may be located in a cloud, even though it is not shown in a cloud in FIG. 7. On the other hand, computer 1101 is not required to be in a cloud except to any extent as may be affirmatively indicated.

PROCESSOR SET 1110 includes one, or more, computer processors of any type now known or to be developed in the future. Processing circuitry 1120 may be distributed over multiple packages, for example, multiple, coordinated integrated circuit chips. Processing circuitry 1120 may implement multiple processor threads and/or multiple processor cores. Cache 1121 is memory that is located in the processor chip package(s) and is typically used for data or code that should be available for rapid access by the threads or cores running on processor set 1110. Cache memories are typically organized into multiple levels depending upon relative proximity to the processing circuitry. Alternatively, some, or all, of the cache for the processor set may be located “off chip.” In some computing environments, processor set 1110 may be designed for working with qubits and performing quantum computing.

Computer readable program instructions are typically loaded onto computer 1101 to cause a series of operational steps to be performed by processor set 1110 of computer 1101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1121 and the other storage media discussed below. The program instructions, and associated data, are accessed by processor set 1110 to control and direct performance of the inventive methods. In computing environment 1100, at least some of the instructions for performing the inventive methods may be stored in block 1200 in persistent storage 1113.

COMMUNICATION FABRIC 1111 is the signal conduction paths that allow the various components of computer 1101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1112 is any type of volatile memory now known or to be developed in the future. Examples include dynamic type random access memory (RAM) or static type RAM. Typically, the volatile memory is characterized by random access, but this is not required unless affirmatively indicated. In computer 1101, the volatile memory 1112 is located in a single package and is internal to computer 1101, but, alternatively or additionally, the volatile memory may be distributed over multiple packages and/or located externally with respect to computer 1101.

PERSISTENT STORAGE 1113 is any form of non-volatile storage for computers that is now known or to be developed in the future. The non-volatility of this storage means that the stored data is maintained regardless of whether power is being supplied to computer 1101 and/or directly to persistent storage 1113. Persistent storage 1113 may be a read only memory (ROM), but typically at least a portion of the persistent storage allows writing of data, deletion of data and re-writing of data. Some familiar forms of persistent storage include magnetic disks and solid state storage devices. Operating system 1122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 1114 includes the set of peripheral devices of computer 1101. Data communication connections between the peripheral devices and the other components of computer 1101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1123 may include components such as a display screen, speaker, microphone, wearable devices (such as goggles and smart watches), keyboard, mouse, printer, touchpad, game controllers, and haptic devices. Storage 1124 is external storage, such as an external hard drive, or insertable storage, such as an SD card. Storage 1124 may be persistent and/or volatile. In some embodiments, storage 1124 may take the form of a quantum computing storage device for storing data in the form of qubits. In embodiments where computer 1101 is required to have a large amount of storage (for example, where computer 1101 locally stores and manages a large database) then this storage may be provided by peripheral storage devices designed for storing very large amounts of data, such as a storage area network (SAN) that is shared by multiple, geographically distributed computers. IoT sensor set 1125 is made up of sensors that can be used in Internet of Things applications. For example, one sensor may be a thermometer and another sensor may be a motion detector.

NETWORK MODULE 1115 is the collection of computer software, hardware, and firmware that allows computer 1101 to communicate with other computers through WAN 1102. Network module 1115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1115 are performed on the same physical hardware device. In other embodiments (for example, embodiments that utilize software-defined networking (SDN)), the control functions and the forwarding functions of network module 1115 are performed on physically separate devices, such that the control functions manage several different network hardware devices. Computer readable program instructions for performing the inventive methods can typically be downloaded to computer 1101 from an external computer or external storage device through a network adapter card or network interface included in network module 1115.

WAN 1102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1103 is any computer system that is used and controlled by an end user (for example, a customer of an enterprise that operates computer 1101), and may take any of the forms discussed above in connection with computer 1101. EUD 1103 typically receives helpful and useful data from the operations of computer 1101. For example, in a hypothetical case where computer 1101 is designed to provide a recommendation to an end user, this recommendation would typically be communicated from network module 1115 of computer 1101 through WAN 1102 to EUD 1103. In this way, EUD 1103 can display, or otherwise present, the recommendation to an end user. In some embodiments, EUD 1103 may be a client device, such as thin client, heavy client, mainframe computer, desktop computer and so on.

REMOTE SERVER 1104 is any computer system that serves at least some data and/or functionality to computer 1101. Remote server 1104 may be controlled and used by the same entity that operates computer 1101. Remote server 1104 represents the machine(s) that collect and store helpful and useful data for use by other computers, such as computer 1101. For example, in a hypothetical case where computer 1101 is designed and programmed to provide a recommendation based on historical data, then this historical data may be provided to computer 1101 from remote database 1130 of remote server 1104.

PUBLIC CLOUD 1105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1105 is performed by the computer hardware and/or software of cloud orchestration module 1141. The computing resources provided by public cloud 1105 are typically implemented by virtual computing environments that run on various computers making up the computers of host physical machine set 1142, which is the universe of physical computers in and/or available to public cloud 1105. The virtual computing environments (VCEs) typically take the form of virtual machines from virtual machine set 1143 and/or containers from container set 1144. It is understood that these VCEs may be stored as images and may be transferred among and between the various physical machine hosts, either as images or after instantiation of the VCE. Cloud orchestration module 1141 manages the transfer and storage of images, deploys new instantiations of VCEs and manages active instantiations of VCE deployments. Gateway 1140 is the collection of computer software, hardware, and firmware that allows public cloud 1105 to communicate through WAN 1102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1106 is similar to public cloud 1105, except that the computing resources are only available for use by a single enterprise. While private cloud 1106 is depicted as being in communication with WAN 1102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1105 and private cloud 1106 are both part of a larger hybrid cloud.

What is claimed is:

1. A computer implemented method for determining an electrical grid power source using a power line signal, comprising:
establishing electronic communication using a power line between a host device and power supply units (PSUs) on an electrical power grid;
using the host device, designating a PSU as a signal generator, and designating remaining PSUs as signal receivers;
generating, using the host device, a signal onto the power line used by the PSUs;
detecting the signal at each of the receivers on the power line;
responding, by one of the receivers, to the host device, in response to detecting the signal at the receiver; and
reporting to an electronic communication device, using the host device, the signal being detected by the receiver.

2. The method of claim 1, wherein the host device is a microcontroller.

3. The method of claim 1, wherein the signal is a unique signal distinguishable from other signals on the power line.

4. The method of claim 1, wherein the unique signal is generated from a microcontroller as the host device and the microcontroller is part of a power supply unit on the electrical power grid.

5. The method of claim 1, wherein the communication to the user includes displaying on a display of the device a textual communication indicating the detection of the signal by the receiver.

6. The method of claim 1, further comprising:
generating the signal using a signal generator communicating through an EMI (Electromagnetic Interference) filter.

7. The method of claim 1, further comprising:
generating the signal using a regulation modulator communicating through a PFC (Power Factor Correction) circuit.

8. The method of claim 1, further comprising:
designating one of a plurality of devices, as the host device, and each of the plurality of devices electrically communicating with the PSUs on the electrical grid, respectively.

9. The method of claim 8, further comprising:
designating each of the plurality of devices, in succession during a time period, as the host device, and correspondingly each of the PSUs as the receivers.

10. The method of claim 1, wherein the reporting to the device communicates (display) to a user the receiving of the signal by the receiver.

11. A system for determining an electrical grid power source using a power line signal, which comprises:
a host device and power supply units (PSUs) using an electrical power grid and electrically communicating;
a PSU associated with the host device being designated as a signal generator, and the remaining PSUs being designated as signal receivers; and
a signal being generatable using the host device onto the power line used by the PSUs and being detectable by each of the receivers, a response to the host device being generated by one of the receivers when the signal is detected at the one of the receivers on the power line, and a communication being sent to an electronic communication device by the host device, to indicate that the signal was detected by the receiver.

12. The system of claim 11, wherein the host device is a microcontroller.

13. The system of claim 11, wherein the signal is a unique signal distinguishable from other signals on the power line.

14. The system of claim 11, wherein the unique signal is generated from a microcontroller as the host device and the microcontroller is part of a power supply unit on the electrical power grid.

15. The system of claim 11, wherein the communication to the user includes displaying on a display of the device a textual communication indicating the detection of the signal by the receiver.

16. The system of claim 11, further comprising:
generating the signal using a signal generator communicating through an EMI (Electromagnetic Interference) filter.

17. The system of claim 11, further comprising:
generating the signal using a regulation modulator communicating through a PFC (Power Factor Correction) circuit.

18. The system of claim 11, further comprising:
designating one of a plurality of devices, as the host device, and each of the plurality of devices electrically communicating with the PSUs on the electrical grid, respectively.

19. The system of claim 18, further comprising:
designating each of the plurality of devices, in succession during a time period, as the host device, and correspondingly each of the PSUs as the receivers.

20. An apparatus for determining an electrical grid power source using a power line signal, which comprises:
a host device electrically communicating with an electrical power grid, the host device communicating with power supply units (PSUs) using the electrical power grid, a PSU being designated as a signal generator, and the remaining PSUs being designated as receivers, a signal being generatable using the host device onto a power line of the electrical grid used by the PSUs and being detectable by each of the receivers, a response to the host device being generated by one of the receivers when the signal is detected at the one of the receivers on the power line, and a communication being sent to an electronic communication device by the host device, to indicate that the signal was detected by the receiver.

21. A system for determining an electrical grid power source using a power line signal, which comprises:
a computer system comprising; a computer processor, a computer-readable storage medium, and program instructions stored on the computer-readable storage medium being executable by the processor, to cause the computer system to perform the following functions to;
establish electronic communication using a power line between a host device and power supply units on an electrical power grid;
using the host device, designate a PSU as a signal generator, and designate remaining PSUs as signal receivers;
generate, using the host device, a signal onto the power line used by the PSUs;
detect the signal at each of the receivers on the power line;
respond, by one of the receivers, to the host device, in response to detecting the signal at the receiver; and
report to an electronic communication device, using the host device, the signal being detected by the receiver.
